(19) United States
(12) Patent Application Publication
(10) Pub. No.: US 2009/0201914 A1
(43) Pub. Date: Aug. 13, 2009

(54) METHOD AND SYSTEM FOR AUTHORIZATION CHECKING WHEN SETTING UP A CONNECTION

(75) Inventor: Klaus Hoffmann, München (DE)

Correspondence Address: K&L Gates LLP, P.O. BOX 1135, CHICAGO, IL, 60690, US

(73) Assignee: Nokia Siemens Networks GmbH, Munchen (DE)

(21) Appl. No.: 12/298,668

(22) PCT Filed: Feb. 3, 2007
(86) PCT No.: PCT/EP07/00939

§ 371 Date: Oct. 27, 2008

(30) Foreign Application Priority Data
Apr. 27, 2006 (EP) 06008746.7

(51) Int. Cl. H04L 12/66; H04L 29/06

(52) U.S. Cl. 370/352; 726/4

(57) ABSTRACT

Present-day on-line charging mechanisms make it possible, in a non-blocking application, for the setting up of a connection to be allowed initially even though it is not yet clear, or cannot be clarified at this time whether a prepaid subscriber (SIP client) still has sufficient money in his account. This therefore leads to a call being signalled to a subscriber (Subs) to be called (it rings), and the call must then be cleared if there is not enough money in the account. In order to avoid this “ghost ringing”, but nevertheless to ensure that connections are set up quickly, a method is proposed which includes an address element, for example the last digit, being withheld, until authorization is obtained from the On-line Charging System (OCS). Alternatively, a connection is set up with a prior condition of “do not ring”, in accordance with IETF RFC 3212. The invention can also be used for other non-monetary authorizations, for example for “lawful interception”.

The present invention relates to a method with an authorization check when setting up a call from an A subscriber, connected to a packet-switched network, to a B subscriber in line with the preamble of patent claim 1 and to a system for carrying out said method.

The text which follows uses the nomenclature from the ITU-T and IETF standards, such as “IP gateway”, “ghost ringing”, “charging” or “advice of charge” AoC. It also uses generally known short terms such as “routing”, “bearer”, “lawful interception”, etc. A list of the abbreviations and terms used, at the end of this document, is an integral part of this specification; the vocabulary from [1] also provides support.

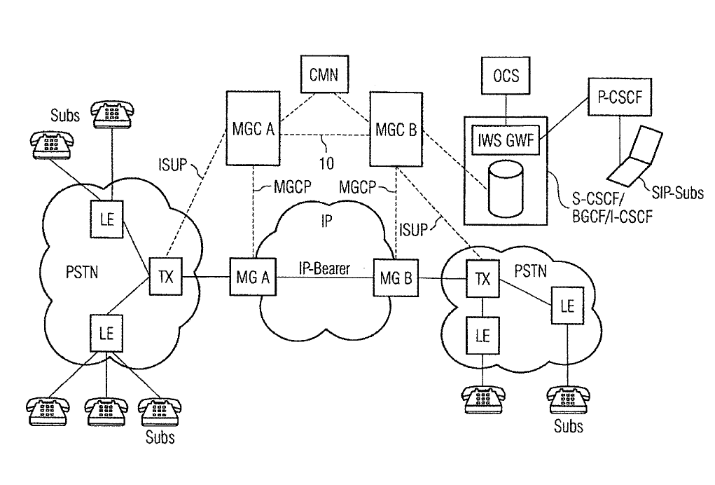

More recent communication architectures provide for call-processing networks to be divided into call-service-related units and the transport of the useful information (bearer control). The basic architecture is shown in FIG. 1. This results in decomposition/division of call setup and medium or bearer setup. In this context, the useful information can be transmitted (the useful channel can be switched through) using various high-bit-rate transport technologies, such as ATM, IP or Frame Relay. The media gateways MG A, MG B can be controlled by respective associated media gateway controllers MGC A, MGC B. To control the media gateways MG A, MG B, the media gateway controllers MGC A, MGC B use standardized protocols, such as the MGCP protocol [2]. To communicate with one another, the media gateway controllers MGC A, MGC B use a BICC (Bearer Independent Call Control) protocol, standardized by the ITU-T, which is formed from a plurality of standardized protocols and therefore comprises a protocol family [3].

Initial basic considerations have resulted in the draft recommendation Q.1912.5 “Interworking SIP and BICC/ISUP” [3] within the ITU-T. This contains no details regarding charging.

3GPP TS 23.240 [4] deals with charging, specifically in the forms
“offline charging functions” in section 4.3.1 and
“online charging functions” in section 4.3.2.

For the “online charging” case, it is proposed, in line with section 4.3.2.1 in [4], that, to determine that the subscriber in question still has credit available, the call setup should be interrupted, i.e. not started in the first place, until a response has been received from the account server, so that the call setup is then continued if there is still sufficient credit available for this account. However, the drawback is that the call setup is delayed. To get around this delay, an optimization has been thought up, in line with section 5.2.2 in [4]:
i) The network element allows the “user session” to start before receipt of the authorization from the OCS, that is to say before the credit control session starts, cf. page 31, center, item 1) in [4].
ii) The OCS denies the request to start, that is to say that a credit control session is not started. In this case, the network element NE prohibits the call setup or, if the call has already been set up, it is terminated, cf. page 31, center, item 2) in [4].

This optimization is provided for the situation in which, unlike in section 4.3.2.1 in [4], particularly the following targets are not met:

The charging trigger function CTF must be able to delay the call setup until clearance has been given by the online charging system OCS.

In this case, it was necessary to establish that, at present, online charging in the case of the nonblocking application (do not hinder call setup in the CSCF) initially permits the call setup, even though it is not yet clear or might not yet have been clear at this time whether a prepaid subscriber still has sufficient money in the account. Therefore, this results in a call being signaled to the B subscriber (his telephone rings) and then the call needing to be disconnected if there is not sufficient money in the account. This phenomenon is referred to as “ghost ringing” for the B subscriber. However, this nevertheless, that is to say with the option in section 5.2.2 of [4], results in disturbances for the B subscriber and embarrassing consultation with the A subscriber, since the B subscriber can see the A subscriber's telephone number and notices that the call has had to be terminated again. For this reason, a solution is required which does not cause any annoying disturbances for the B subscriber. These annoying disturbances arise not only for the conventional voice service but are also manifested for FAX calls, in this case particularly for FAX polling and for video calls.

A detailed discussion of the problem of sufficient (prepaid) credit has been provided above. In a more general context, there are also other significant reasons for being able to reserve resources to the greatest possible extent but for rendering their use dependent on the presence of authorization. This is also relevant for the service “lawful interception”, for example. For conventional circuit switching, this service is specified in ETSI TR 102 053 [7]. More general concepts for “lawful interception” can be found in the document ETSI RT 101 943 [6].

The present invention is therefore based on the object of specifying a method with an authorization check which, depending on a condition, e.g. sufficient credit in an account belonging to an A subscriber, allows rapid call setup without a call/ringing being sent to the B subscriber in the case of insufficient credit, which call/ringing would then subsequently need to be terminated again, or without a service being able to be connected only with a delay, e.g. in the case of “lawful interception”.

This object is achieved for a method of the type cited at the outset by the features specified in patent claim 1.

The method according to the invention, according to which
“the call setup is initiated but not completed while there is no message from the authorization server (AuS) stating that sufficient authorization is available for the call or for a service which is to be connected to this call”;
   initiates an “alert” (the telephone rings) for the subscriber only if authorization is assured for one of the subscribers for the imminent use or activation of a service. The fact that the call setup has been initiated but not completed means that it is not necessary to wait for the connection for a long time when a “resource usage authorization” is available, however.

Further advantageous refinements of the invention are specified in further claims. In particular, the conventional addressing with an E.164 number allows the present invention to be implemented particularly easily by virtue of dial up to the last digit and forwarding of the last digit only after the “resource usage authorization” is available. It should be noted that this is not done at the A subscriber's end, where block dialing may be obligatory, as in the case of GSM, for example, but rather that the last digit is withheld in the network at that location which provides the online charging function, in this case the call server control function CSCF, for example.

The invention is explained in more detail below by way of example with reference to the drawing, in which:

FIG. 1 shows the architecture of a communication network with SIP and PSTN subscribers.

An embodiment of the present invention is explained for the case of sufficient charge credit. This is done using terms and functions from the document 3GPP TS 23.240 [4] . To this end, an online charging system OCS within the meaning of the document is assumed. In particular, figure 4.3.1 from the document 3GPP TS 23.240 [4] and the functions shown therein are incorporated herewith, without this figure being included in this document.

The invention is in no way limited thereto, however, but rather can also be applied to lawful interception, for example.

The single FIG. 1 shows an architecture for a communication network with an SIP client and PSTN subscribers. For the exemplary embodiment, it is assumed that the SIP client is the A subscriber and one of the subscribers labeled Subs in FIG. 1 is the relevant B subscriber.

A preferred embodiment of the present invention, i.e. of a method for realtime charging, is explained with reference to tables 1 and 2. Table 1 contains the case in which there is sufficient credit in an account in the “online charging system” OCS for the call setup by the A subscriber. For the sake of simplicity, A subscriber is abbreviated to Asub and B subscriber is abbreviated to Bsub.

Process assuming sufficient credit:

TABLE 1
Process assuming sufficient credit.

| A-party | | | |
|---|---|---|---|
| endpoint | CSCF | OCF/OCS | B-party endpoint |
| INVITE | INVITE with | OCF is | |
| without | precondition indication | informed | |
| precon- | (RFC 3312) in SDP to B | by CSCF | |
| dition | party | (CTF) and | |
| indication | → | asked | |
| (RFC 3312) | m=audio 30000 RTP/AVP 0 | whether | |
| with SDP | c=IN IP4 192.0.2.4 | credit | |
| → | a=curr:qos local none | available | |
| | a=curr:qos remote | | |
| | sendrecv | | |
| | a=des:qos mandatory | | |
| | local sendrecv | | |
| | a=des:qos mandatory | | |
| | remote sendrecv | | |
| | In addition the option | | |
| | tag “precondition” in | | |
| | the Require header if | | |
| | not present: | | |
| | possibly also “100rel” | | |
| | tag in the Supported | | |
| | header field and SHOULD | | |
| | include an Allow header | | |
| | field with the “UPDATE” | | |
| | tag | | |
| | | | Following receipt of |
| | | | the INVITE, B sends |
| | | | a 183 with SDP also |
| | | | (subscriber is not |
| | | | yet called, |
| | | | preconditions need |
| | | | to be met) |
| | | | ← |
| | | | m=audio 20000 |
| | | | RTP/AVP 0 |
| | | | c=IN IP4 192.0.2.1 |
| | | | a=curr:qos local |
| | | | sendrecv |
| | | | a=curr:qos remote |
| | | | none |
| | | | a=des:qos mandatory |
| | | | local sendrecv |
| | | | a=des:qos mandatory |
| | | | remote sendrecv |
| | CSCF receives the 183 | | |
| | from B and does not | | |
| | forward this 183 to the | | |
| | Asub, | | |
| | because the CSCF | | |
| | modified the INVITE in | | |
| | the initial INVITE so | | |
| | that the Bsub is not | | |
| | yet called | | |
| | | OCF | |
| | | responds | |
| | | and with | |
| | | sufficient | |
| | | credit | |
| | | for Asub | |
| | CSCF has received | | |
| | positive response from | | |
| | OCF and sends PRACK SDP | | |
| | to B party | | |
| | → | | |
| | m=audio 30000 RTP/AVP 0 | | |
| | c=IN IP4 192.0.2.4 | | |
| | a=curr:qos local | | |
| | sendrecv | | |
| | a=curr:qos remote | | |
| | sendrecv | | |
| | a=des:qos mandatory | | |
| | local sendrecv | | |
| | a=des:qos mandatory | | |
| | remote sendrecv | | |
| | or a PRACK without SDP | | |
| | but instead an UPDATE | | |
| | with the SDP as | | |
| | described for the PRACK | | |
| | | | Bsub receives PRACK |
| | | | (and possibly the |
| | | | UPDATE), which means |
| | | | that the preconditions |
| | | | are met and the |
| | | | subscriber can be |
| | | | called. |
| | | | And responds with a 200 |
| | | | OK to PRACK with SDP |
| | | | (if SDP has been |
| | | | received in the PRACK) |
| | | | or also additionally |
| | | | the 200 OK to the |
| | | | UPDATE with the SDP |
| | | | ← |
| | | | m=audio 20000 RTP/AVP 0 |
| | | | c=IN IP4 192.0.2.1 |
| | | | a=curr:qos local |
| | | | sendrecv |
| | | | a=curr:qos remote |
| | | | sendrecv |
| | | | a=des:qos mandatory |
| | | | local sendrecv |
| | | | a=des:qos mandatory |
| | | | remote sendrecv |
| | CSCF receives the 200 | | |
| | OK for the PRACK from B | | |
| | and does not forward | | |
| | this PRACK to the Asub, | | |
| | because the CSCF | | |
| | modifies the INVITE in | | |
| | the initial INVITE and | | |
| | has generated the PRACK | | |
| | itself. | | |
| | | | Since the Bsub has been |
| | | | called, the 180 ringing |
| | | | can now be sent |

Process assuming insufficient credit:

TABLE 2
Process assuming insuffient credit

| A-party | | | B-party endpoint |
|---|---|---|---|
| endpoint | CSCF | OCF | supports RFC3212 |
| INVITE | INVITE with | Is | |
| without | precondition indication | informed | |
| precon- | (RFC 3312) in SDP to | and asked | |
| dition | Bsub | whether | |
| indication | → | credit | |
| (RFC 3312) | m=audio 30000 RTP/AVP 0 | available | |
| with SDP | c=IN IP4 192.0.2.4 | | |
| offer | a-curr:qos local none | | |
| → | a=curr:qos remote | | |
| | sendrecv | | |
| | a=des:qos mandatory | | |
| | local sendrecv | | |
| | a=des:qos mandatory | | |
| | remote sendrecv | | |
| | Additionally the option | | |
| | tag “precondition” in | | |
| | the Require header if | | |
| | not present: | | |
| | possibly also “100rel” | | |
| | tag in the Supported | | |
| | header field and SHOULD | | |
| | include an Allow header | | |
| | field with the “UPDATE” | | |
| | tag | | |
| | | | Following receipt of |
| | | | the INVITE, B sends |
| | | | a 183 with SDP also |
| | | | (subscriber is not |
| | | | yet called, |
| | | | preconditions need |
| | | | to be met) |
| | | | ← |
| | | | m=audio 20000 |
| | | | RTP/AVP 0 |
| | | | c=IN IP4 192.0.2.1 |
| | | | a=curr:qos local |
| | | | sendrecv |
| | | | a=curr:qos remote |
| | | | none |
| | | | a=des:qos mandatory |
| | | | local sendrecv |
| | | | a=des:qos mandatory |
| | | | remote sendrecv |
| | CSCF receives the 183 | | |
| | from B and does not | | |
| | forward this 183 to the | | |
| | Asub, because the CSCF | | |
| | has modified the INVITE | | |
| | in the initial INVITE | | |
| | so that the Bsub's | | |
| | telephone does not yet | | |
| | ring. | | |
| | | OCF | |
| | | responds | |
| | | and there | |
| | | is not | |
| | | enough | |
| | | credit | |
| | | for Asub. | |
| | CSCF has received | | |
| | negative response from | | |
| | OCF and CANCEL | | |
| | → | | |
| | | | Bsub receives CANCEL, |
| | | | sends 200 for the |
| | | | CANCEL, and the |
| | | | connection attempt is |
| | | | terminated. |
| | | | ←−200 OK for the CANCEL |
| | | | The response 487 |
| | | | request terminated is |
| | | | sent for the CANCEL as |
| | | | standard. |
| | | | The Bsub's telephone |
| | | | does not ring. |
| | Call is set up as | | |
| | standard. | | |

The aforementioned support based on RFC3212 can be understood as follows:

In line with section 5 “usage of preconditions”, the RFC3212 [5] basically provides the option of reserving resources in the event of a call setup in SIP and calling the B subscriber only if guaranteed setup of the bearer (voice channel) is successful. In this case, the signaling has been sent to the Bsub, but with the indication that the Bsub must not actually be rung yet, since the preconditions for assuring the quality of the call have not yet been met, since the resources must first of all still be reserved/guaranteed. A piece of logic in the terminal (may also be an MGCF/MGW, etc,—MGCF: media gateway control function; MGW: media gateway) can prevent the Bsub's telephone from ringing by means of the SIP signaling using the SDP protocol RFC2327 “SDP: session description protocol”.

According to IETF RFC 3312 section 6 [5], a user agent server, which thus receives an SDP offer with “preconditions”, should not yet ring the Bsub's telephone. Only when the necessary preconditions are met will the subscriber then actually be called. The preconditions are sent concurrently in the SDP and, when the preconditions have been met, are in turn sent to the Bsub, so that the B-party terminal is now also informed of this and then calls the Bsub.

In the case here, this mechanism is now reused in order to quickly set up the call to the Bsub but not yet to ring the telephone. Only if the prepaid account has sufficient money, that is to say that the positive response has been received from the charging system OCS, is the indication that the preconditions are met then sent to the Bsub. Consequently, the terminal recognizes this and now calls the subscriber only after it is guaranteed that there is sufficient budget available. What are known as ring disturbances therefore do not arise.

### List of Reference Symbols and Acronyms Used; Glossary

3GGP 3rd Generation Partnership Project http://www.3gpp.org
ABMF Account Balance Management Function
AuS Authorization server, non standardized term; the term “authorization server” also covers an online charging system
BGCF Breakout Gateway Control Function
CSCF Call Server Control Function
CTF Charging Trigger Function
I-CSCF Interrogating CSCF
IP Internet Protocol
ISDN Integrated Service Digital Network
ISUP ISDN User Part
ITU-T Telecommunication Standardization sector of ITU
LE Line Exchange; Local Exchange
MG Media Gateway
MGC Media Gateway Control
OCF Online Charging Function
OCS Online Charging System
P-CSCF Proxy CSCF
PSTN Public Switched Telecommunication Network
RF Rating Function
RFC Request For Comment
S-CSCF Serving CSCF
SE Service Element
SIP Session Initiation Protocol
SIP-Subs SIP subscriber and SIP client are used synomously
SS Subsystem, also called IMS IP multi media subsystem
Subs Subscriber
TX Transit Exchange;
10 MGC-MGC signaling (bearer setup)

### Bibliography

[1] 3GPP TR 21.905
   3rd Generation Partnership Project; Technical specification group services and system aspects; vocabulary for 3GPP specifications (release 7)
[2] IETF RFC2705
   Media Gateway Control Protocol (MGCP) Version 1.0. M. Arango, A. Dugan, I. Elliott, C. Huitema, S. Pickett. October 1999, Obsoleted by RFC3435, Updated by RFC3660.
[3] ITU-T Q.1912.5
   Interworking between Session Initiation Protocol (SIP) and Bearer Independent Call Control protocol or ISDN User Part
[4] 3GPP TS 23.240
   3rd Generation Partnership Project; Technical Specification
   Universal Mobile Telecommunications System (UMTS);
   Telecommunication management; Charging management;
   Charging architecture and principles (3GPP TS 32.240 version 6.3.0 Release 6)
[5] IETF RFC 3312
   Integration of Resource Management and Session Initiation Protocol (SIP)
   G. Camarillo, Ed. Ericsson, W. Marshall, Ed. AT&T, J. Rosenberg dynamicsoft. October 2002.
[6] ETSI TR 101 943 V2.1.1 (2004-10) Lawful Interception (LI); Concepts of Interception in a Generic Network Architecture
[7] ETSI TR 102 053 V1.1.1 (2002-03)
   Telecommunications security; Lawful Interception (LI); Notes on ISDN lawful interception functionality

1. A method for checking authorization when setting up a call from an A subscriber (SIP-Subs), connected to a packet-switched network (IP), to a B subscriber (Subs), who can be addressed by a string of digits, wherein an authorization is managed for one of the subscribers in an authorization server (AuS),
the call setup is initiated but not completed while there is no message from the authorization server (AuS) stating that authorization is available for the call or for a service which is to be connected to this call.

2. The method as claimed in claim 1,
the call setup is initiated for the time being with the exception of the last digit in the string of digits addressing the B subscriber (Subs).

3. The method as claimed in claim 1,
the authorization server (Aus) is in the form of an account managed for the A subscriber (SIP-Subs) in a charging system (OCS), and the message represents adequate credit for the A subscriber in question (SIP-Subs).

4. The method as claimed in claim 3,
the A subscriber (SIP-Subs) is associated with an SIP domain, wherein the charging system (OCS) is managed on the basis of the prepaid method and the last digit is sent with an SIP-INVITE message.

5. The method as claimed in claim 1,
the call setup is initiated with a precondition stating that it is not yet possible to apply any call/ringing to the B subscriber (Subs).

6. The method as claimed in claim 5,
the precondition is specified in line with RFC 3312.

7. The method as claimed in claim 6,
the precondition is met by means of a positive acknowledgement from the charging system (OCS).

8. A system having means for carrying out the steps of the method as claimed in claim 1.
